(19) United States
(12) Patent Application Publication
(10) Pub. No.: US 2007/0139213 A1
(43) Pub. Date: Jun. 21, 2007

(54) REMOTE ACTIVATED KILL SWITCH SYSTEM

(76) Inventors: Thomas W. Akers, Wetumpka, AL (US); William F. Hall, Jacksonville, NC (US); Wyatt E. Orendorf, Montgomery, AL (US)

Correspondence Address: WALTER J, TENCZA JR., 10 STATION PLACE, SUITE 3, METUCHEN, NJ, 08840, US

(21) Appl. No.: 11/306,237

(22) Filed: Dec. 20, 2005

(51) Int. Cl. G08C 19/00

(52) U.S. Cl. 340/825.69; 340/5.61; 340/426.11; 307/10.2; 340/10.1

(57) ABSTRACT

An apparatus comprising a vehicle identification electronic chip, a transmitter/receiver, and an ignition system is disclosed. The vehicle identification electronic chip supplies a vehicle identification number to a remote device in response to an activation signal. The apparatus may further include an on/off switch. The transmitter/receiver may receive a stop signal from the remote device and cause the on/off switch to turn the ignition system off in response to the stop signal.

### FIELD OF THE INVENTION

This invention relates to improved methods and apparatus concerning reducing high speed police chases.

### BACKGROUND OF THE INVENTION

Police vehicles often engage in high speed pursuits with fleeing vehicles. These high speed pursuits cause loss of life and damage to property.

### SUMMARY OF THE INVENTION

The present invention in one or more embodiments provides an apparatus comprising a vehicle identification electronic chip, a transmitter/receiver, and an ignition system. The vehicle identification electronic chip supplies a vehicle identification number to a remote device in response to an activation signal from the remote device received through the transmitter/receiver and supplied to the vehicle identification electronic chip. The apparatus may further include an on/off switch. The transmitter/receiver receives a stop signal from the remote device and causes the on/off switch to turn the ignition system off in response to the stop signal.

In one embodiment of the present invention, a method is provided including supplying a vehicle identification number to a remote device in response to an activation signal from the remote device. The activation signal can be received through a transmitter/receiver and supplied to a vehicle identification electronic chip. The method may further include receiving a stop signal from the remote device through the transmitter/receiver and causing an on/off switch to turn an ignition system off in response to the stop signal.

### BRIEF DESCRIPTION OF THE DRAWINGS

FIG. 1 shows diagram of a system and apparatus in accordance with an embodiment of the present invention.

### DETAILED DESCRIPTION OF THE DRAWINGS

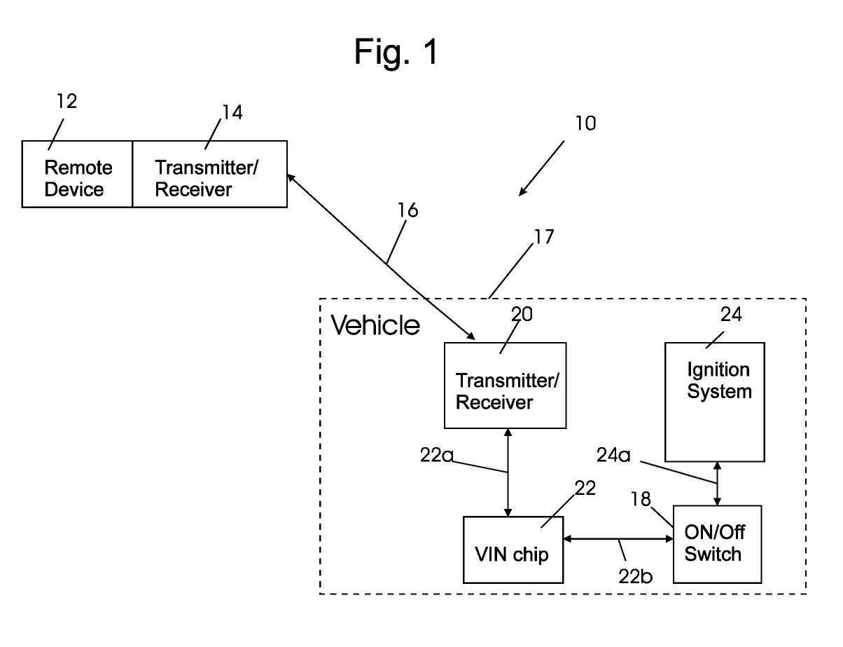

FIG. 1 shows diagram of a system and an apparatus 10 in accordance with an embodiment of the present invention. The apparatus 10 includes a remote device 12, a transmitter/receiver 14, a communications channel 16 and a vehicle 17. The vehicle 17 includes an on/off switch 18, a transmitter/receiver 20, a vehicle identification (VIN) chip 22, and an ignition system 24. The vehicle identification chip 22 may be unique to the vehicle 17 and the chip 22 may be proprietary to the manufacturer of the vehicle 17.

The transmitter receiver 20 may be electrically connected to the VIN chip or processor 22 through communications line or bus 22a. The VIN chip 22 may be electrically connected to the on/off switch 18 through communications line or bus 22b. The on/off switch 18 may be electrically connected to ignition system 24 through communications line or bus 24a.

The vehicle identification chip 22 may be an integrated circuit, which contains computer software. The chip 22 is programmed with the vehicle identification number of the vehicle 17. The vehicle identification chip 22 is installed in or with the ignition system 24. The ignition system 24 may be a typical existing automobile ignition system installed by an automobile manufacturer into the vehicle 17. The vehicle identification chip 22 may control the on/off switch 18 and determine whether the on/off switch 18 is on or off.

The vehicle identification chip 22 remains dormant until the chip 22 is queried or activated by the remote device 12. The remote device 12 includes the transmitter/receiver 14, which transmits an activation signal or query signal via communications channel 16 to the transmitter/receiver 20, which is part of or operatively connected to the ignition system 24. The query signal transmitted via communications channel 16 may be encrypted.

The remote device 12 may be a RADAR gun or other similar device. When queried, or activated by the remote device 12, the transmitter/receiver 20 will transmit the VIN of the vehicle 17 to the remote device 12. After the remote device 12 receives the VIN through transmitter receiver 14, the remote device 12 determines whether the vehicle 17 should be stopped. If so, then the remote device 12 transmits a stop signal via transmitter/receiver 14 and communications channel 16. The stop signal transmitted may be encrypted. The stop signal is received by transmitter receiver 20, which supplies the stop signal to the VIN chip 22 or directly to the ignition system 24 to cause the ignition 24 to be turned off so that the vehicle can be stopped. The ignition system 24 may be turned off by the on/off switch 18. The on/off switch 18 may break an electronic circuit remotely causing ignition system 24 to be disabled and unharmed.

If it is decided to allow the vehicle 17 to resume operation, then the remote device 12 can send a start signal through transmitter receiver 14 and communications channel 16 to the transmitter/receiver 20. The start signal is received by transmitter/receiver 20 and supplied to the ignition system 24, such as through the VIN chip 22, to cause the ignition system 24 to start. For diesel fueled vehicles, the same system or substantially the same system as shown in FIG. 1 may be used, however the ignition system 24 may be replaced by a fuel injection system.

At least one embodiment of the present invention allows law enforcement officials using remote device 12 to remotely stop vehicles, such as vehicle 17. This will eliminate or reduce high speed pursuits and thereby minimize or eliminate property damage. This may also save lives since it is reported between 400 and 500 deaths occur annually due to high speed chases and one-third of those deaths are innocent bystanders. At least one embodiment of the present invention minimizes or eliminates “wrongful death” law suits due to law enforcement officials engaging in dangerous chases.

The cost to produce and install components of the apparatus or system 10 is minimal. The apparatus or system 10 provides a safe distance of operation to police. The vehicle 17 may be an automobile, a boat, a motorcycle, or any other type of vehicle.

The remote device 12 may be comprised of a typical RADAR gun modified in accordance with an embodiment of the present invention, to accept a vehicle identification number for vehicle 17 transmitted from transmitter/receiver 20. The remote device 12 may include a display device, not shown, such as a liquid crystal display (LCD) display device able to accept a seventeen to twenty character display for a vehicle identification number.

The system and apparatus 10 of FIG. 1 may be used by all law enforcement agencies, by the U.S. government, or by the U.S. military. They system and apparatus 10 of FIG. 1 may be used to provide law enforcement agencies the tools to safely disable vehicles during “High Speed” pursuits

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising:
a vehicle identification electronic chip;
a transmitter/receiver;
an ignition system;
an on/off switch;
wherein the vehicle identification electronic chip supplies a vehicle identification number to a remote device into response to an activation signal from the remote device received through the transmitter/receiver and supplied to the vehicle identification electronic chip; and
wherein the transmitter/receiver receives a stop signal from the remote device and causes the on/off switch to turn the ignition system off in response to the stop signal.

2. A method comprising:
supplying a vehicle identification number to a remote device into response to an activation signal from the remote device received through a transmitter/receiver and supplied to a vehicle identification electronic chip;
receiving a stop signal from the remote device through the transmitter/receiver;
and causing an on/off switch to turn an ignition system off in response to the stop signal.
